(19) United States
(12) Patent Application Publication
(10) Pub. No.: US 2011/0023983 A1
(43) Pub. Date: Feb. 3, 2011

(54) GAS FLOW MONITOR

(76) Inventor: Norbert Fischer, Magdeburg (DE)

Correspondence Address: HOWARD & HOWARD ATTORNEYS PLLC, 450 West Fourth Street, Royal Oak, MI, 48067, US

(21) Appl. No.: 12/921,553

(22) PCT Filed: Mar. 5, 2009
(86) PCT No.: PCT/EP09/01565

§ 371 Date: Sep. 8, 2010

(30) Foreign Application Priority Data
Mar. 11, 2008 (DE) 10 2008 013 508.9

(51) Int. Cl. F16K 17/30

(52) U.S. Cl. 137/535

(57) ABSTRACT

A gas flow monitor is to be created in which a defined value range of the closing or nominal flow rate can be set by changing the bias of the spring without changing the lift of the closing/valve body with a consequential concomitant reduction or enlargement of the flow gap. For this purpose, the gas flow monitor comprises a gas-tight housing (1), which has a valve seat (5) in its interior for an axially movable closing body (12), and a pin (11) at whose inlet side the closing body (12) is fastened, which with a stop (17) located at its outlet-side end by the force of a closing spring (15) is supported on a guide (6) disposed in the housing (1) on an outlet side by way of a tubular spacer (16). The guide (6) has in its center a sleeve (10), adjustable in an axial direction in which the pin (11) is guided in a longitudinally movable manner. The spacer (16) and the sleeve (10) are firmly connected to each other.

### TECHNICAL FIELD OF THE INVENTION

The invention relates to a gas flow monitor in accordance with the preamble to the first patent claim for automatically shutting off downstream gas conduits when a defined maximum flow is exceeded.

### STATE OF THE ART

Gas flow monitors serve to shut off the gas supply to the downstream gas conduit if gas consumption increases above a preset value, as occurs for example with fractured pipes or inadmissibly high rates of leaks. These devices exist in a wide range of embodiments. They are used in pipes, for example upstream of gas fittings, gas appliances etc. In order to set the required closing and/or nominal flow rate, a spring is biased by adjustable stops in such a way that the resulting force from the pretensioning force of the spring and the flow force of the gas flow causes the gas flow monitor to assume its closed or open position.

A gas flow monitor, which is also described as a safety shut-off device for gas conduits, is known from DE 43 44 575 A1. This safety shut-off device comprises a valve body which can be pressed against a valve seat. The valve body is fitted with a tappet to which a locking element can be attached on which a closing spring is supported whose other end bears on the valve body. The bias of the spring for adjusting the closing flow rate can be altered by altering the position of the locking element on the tappet.

A gas flow monitor, also described as a safety shut-off device, is known from WO 92/01184 A1. This device shuts down the pipework system if it is damaged without however shutting down the supply pipe prematurely if an appliance requires an amount of gas in accordance with its output over an extended period. A valve is constructed as a disc valve in this safety shut-off device.

The valve body of the device is attached to a valve shaft which is displaceably mounted bilaterally in slide bearings in the axial direction of the valve against the force of a spring, with the valve disc interacting with a valve seat located in one of two annular discs, and the annular discs serving simultaneously as a mounting for the slide bearings already referred to above. The annular discs are fitted with recesses or openings.

The spring force of the spring and/or the closing travel of the valve are adjustable to enable the closing flow rate to be matched exactly to the type, nature and number of appliances. To adjust the closing travel of the valve a nut is fitted on the free end of the valve shaft, and screwed up on a thread located on the valve shaft. An adjustment device, which is arranged in the area between the two slide bearings and formed for example as a second nut, serves to adjust the spring force.

Another gas flow monitor is described in DE 100 43 811 B4, comprising a gas-tight housing which is inserted into a pipe through which gas flows. A valve seat for a movable closing body is formed in the interior of the housing. The closing body is attached to an axially movable pin supported on an inlet and outlet guide. The closing body is held in the open position by a closing spring which is supported on one side on an adjusting element screwed into the center of the outlet guide and on the other side on the closing body. In addition, a spacer is arranged on the inlet guide, said spacer forming a stop in the open position of the gas flow monitor for the closing body which is also adjustable.

Another embodiment of a gas flow monitor is known from DE 201 16 899 U1. This gas flow monitor also comprises a housing with a valve seat in its interior and a closing body arranged in the housing, held in its open position in the normal state by a retention force. Attached to the closing body is a guide pin which extends from the closing body through an opening formed in a supporting element in the opposite direction from the valve seat and is guided in that process by said opening. The guide pin has annular grooves at its end opposite to the closing body. An adjusting ring is locked into position in one of the annular grooves. A spring which exerts a compressive force on the adjusting ring is arranged between the adjusting ring and the supporting element. This compressive force forms a retention force which holds the closing body in the open position. The compressive force exerted by the spring and thus the retention force can be altered by locking the adjusting ring in position in another annular groove.

In all the solutions set out above a defined value range of the closing or nominal flow rate is adjusted by changing the bias of a spring which holds the closing/valve body in the open position. The disadvantage of this arrangement is that a change in the lift of the closing/valve body with a consequential concomitant reduction or enlargement of the flow gap occurs simultaneously with the change of bias of the spring. This is associated with a reduction or increase in the force acting on the closing/valve body because of the flow pressure or pressure difference. Because of this simultaneous reduction or increase of the opposed forces, the closing flow rate can be varied only to a limited extent or cannot be varied at all, thereby making adjustment difficult or impossible. A further disadvantage with this arrangement is the change in the pressure loss that occurs across the gas flow monitor. This is particularly problematic in cases where limit values for the flow-through setting must not be exceeded.

### DESCRIPTION OF THE INVENTION

The present invention addresses the problem of developing a gas flow monitor of the type specified in which a defined value range of the closing or nominal flow rate is set by changing the bias of the spring without changing the lift of the closing/valve body with a consequential concomitant reduction or enlargement of the flow gap.

The problem is solved according to the invention as follows: a pin at whose inlet end a closing body is fastened, with a stop located at its outlet side end by the force of a closing spring, is supported on a guide disposed in the housing on an outlet side by way of a tubular spacer. In the center, the guide comprises a sleeve which can be set in the axial direction and in which the pin is guided in a longitudinally movable manner. The spacer and the sleeve are firmly connected to each other.

This solution has provided a way of overcoming the disadvantage of the state of the art described above. The solution according to the invention ensures a uniform flow gap between the housing and the closing body in the open position and therefore constant pressure losses. The adjustment is affected by just one other parameter, the force of the closing spring, thereby enabling a finer adjustment of the desired closing or nominal flow rate to be made in both directions.

Further advantageous embodiments of the invention are set out in the other claims. For example, an attenuation function can easily be integrated into the closing behavior of the gas flow monitor as well. That is always advisable in situations where short-term peak flows may occur in the pipework downstream of the gas flow monitor that exceed normal consumption to such an extent that the closing flow rate set is exceeded. Examples of these include gas appliances that are switched by an abruptly opening solenoid operated valve. This attenuation function prevents the gas flow monitor from being shut off unintentionally even at a closing flow rate set close to normal consumption, a setting which is advisable for safety reasons.

To produce this attenuation function the spacer has a cylindrical extension which is sealed on its front side by a cap. The pin projects into this space created by the extension and the cap, with the stop of the pin being guided in a longitudinally movable manner on the inner wall. This creates a partition of said space. In addition, the volume control, which is required during a movement of the closing body and which is provided by the restriction formed by the stop and inner wall, does not lead to an abrupt shutting down of the gas flow monitor during a peak flow. After the peak flow has passed, the closing body is returned to its open position by the closing spring.

In addition, one embodiment in which the housing and the guide are constructed in one piece has proved to be advantageous for the manufacturing process. In a further embodiment which is also advantageous for the manufacturing process the sleeve is screwed to one side to the guide and pressed to the spacer on the other side or vice versa. It is also possible to form the pin and the stop as one piece by forming the stop as a flange.

### EXECUTION EXAMPLE

The gas flow monitor according to the invention is explained below in more detail by means of execution examples. The diagrams show the following details:

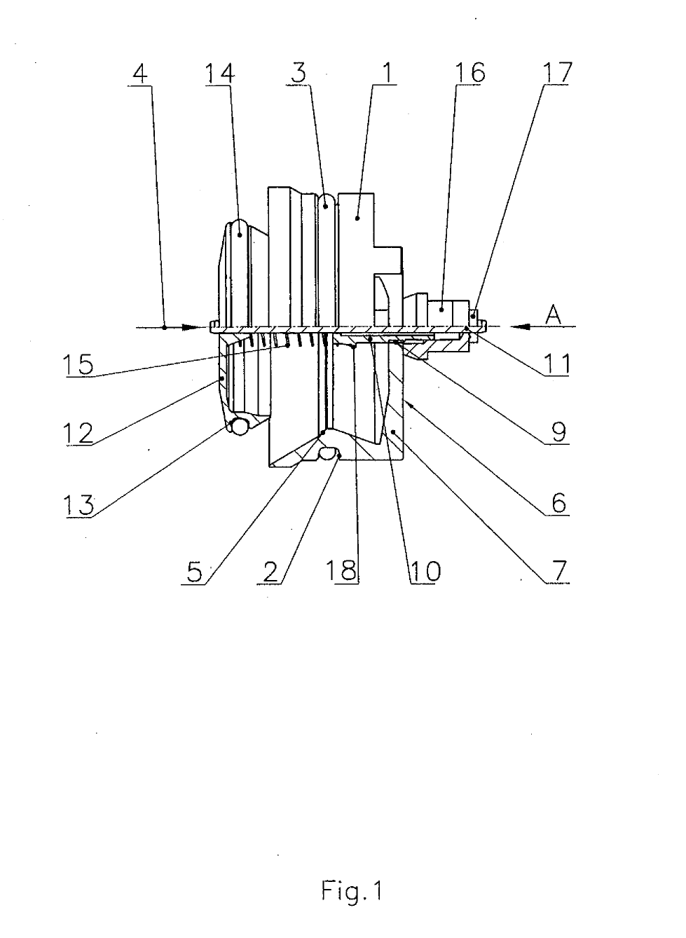

FIG. 1 sectional drawing of a gas flow monitor according to the invention in the open position

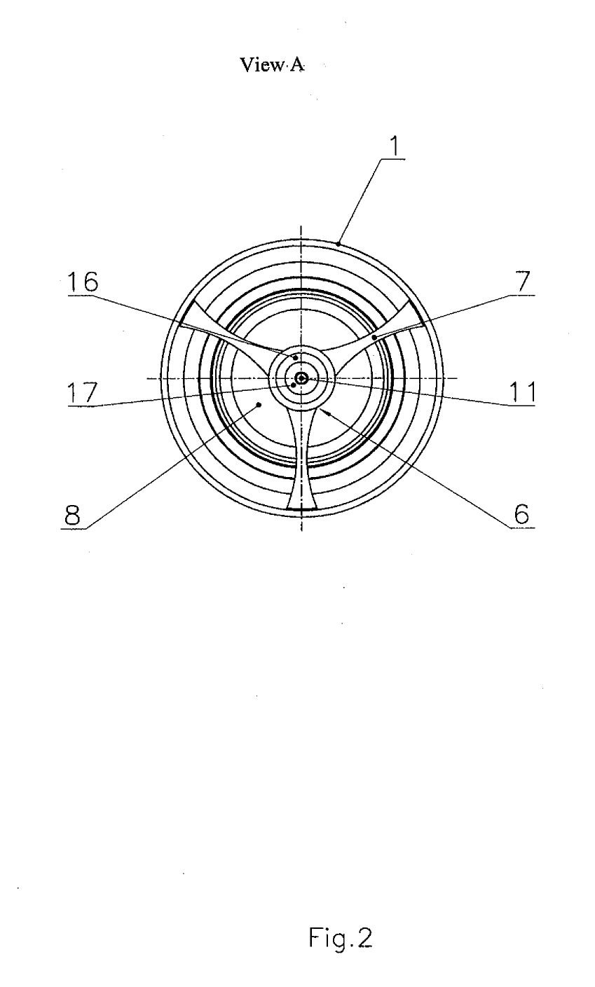

FIG. 2 a view A of the gas flow monitor according to the invention from FIG. 1.

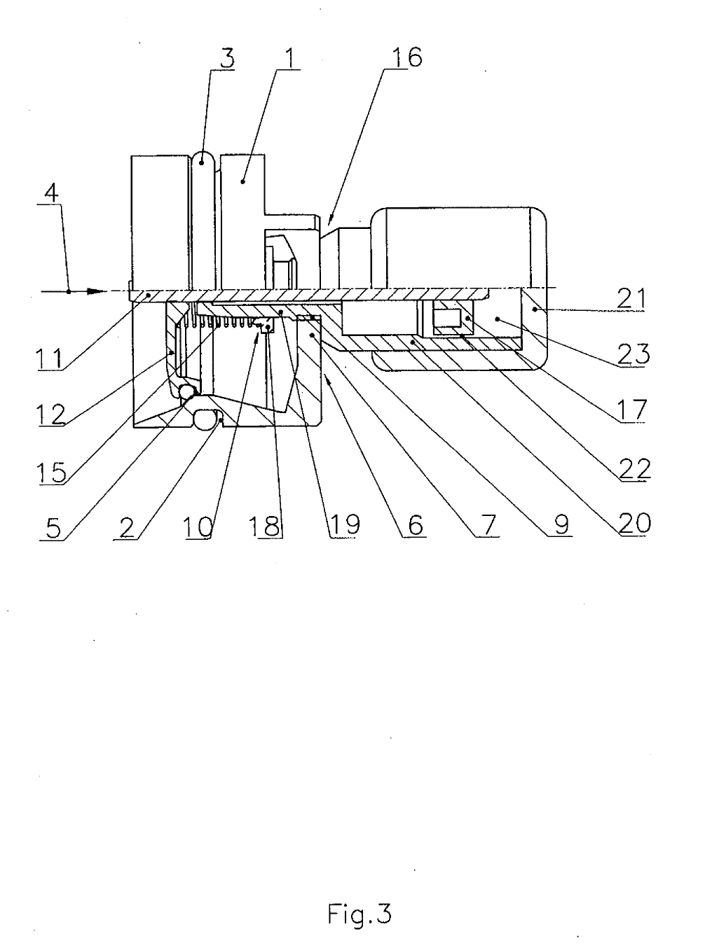

FIG. 3 sectional drawing of a gas flow monitor according to the invention with attenuation function in the closed position

FIG. 1 shows an initial execution example of a gas flow monitor according to the invention. It comprises a tubular housing 1 that can be pushed into a gas conduit (not illustrated). The housing 1 has a circumferential groove 2 in which an O-ring is located in order to ensure the required tightness between the gas conduit and housing 1. Another connection is of course possible.

Gas can flow through the housing 1 in the direction shown by an arrow 4. The housing 1 has a constriction roughly centrally which is formed as a valve seat 5 on its side facing the gas inlet. On the outlet side of the housing 1 there is a guide 6 which has flow through openings 8 formed by several radial webs 7 for the gas flow. The guide 6 is connected integrally to the housing 1 by the webs 7 (FIG. 2) in this execution example.

The guide 6 has in its center in the axial direction a through bore 9 in which a sleeve 10 is mounted in such a way that it can be adjusted in the axial direction. In order to carry out this adjustment as precisely and simply as possible, it has proved to be advantageous to fit the through bore 9 with a thread into which the sleeve 10 is screwed.

A pin 11 is guided in a longitudinally movable manner in the sleeve 10. A closing body 12 is attached on its inlet end by means of press fit for example. The closing body 12 has an annular groove 13 for an O-ring 14 which serves as an elastic sealing element in order to ensure the required tightness in the closed position of the gas flow monitor. A closing spring 15 is supported on a flange 18 of the sleeve 10, with the other end of said spring holding the closing body 12 in its open position.

A tubular spacer 16, which is firmly connected to the sleeve 10, preferably by force fit, is supported on the outlet side of the guide 6.

The pin 11 penetrating the spacer 16 is fitted with a pressed on stop 17 on its end protruding from the spacer 16 on its outlet side. This stop 17 can of course also be constructed integrally with the flange located on the pin 11. The maximal lift of the closing body 12 is determined by the stop 17.

The closing body 12, pin 11 and closing spring 15 are preassembled during assembly and the pin 11 is then pushed through the sleeve 10, which is screwed into the guide 6 almost up to the flange 18. The spacer 16 is placed over the pin 11 and pressed so far onto the sleeve 10 that it bears on the guide 6. The maximum opening lift of the closing body 12 is then set via the stop 17.

The closing or nominal flow rate can now be easily adjusted via the pretensioning force of the closing spring 15 by turning the spacer 16 in such a way that the sleeve 10 is unscrewed out of the spacer 16 in its longitudinal direction because of its threaded connection with the guide 6 until the required value of the closing or nominal flow rate, i.e. the corresponding pretensioning force of the closing spring 15, has been reached. The finer the pitch of the thread chosen, the more accurately the pretensioning force can be set, with the maximum opening lift remaining constant.

A modified embodiment of the gas flow monitor according to the invention is also shown in FIG. 2 in the closed position as a further execution example. This gas flow monitor is fitted with an attenuation device which makes it less sensitive to fluctuations. The necessity for this facility has already been acknowledged above.

Apart from the structure, which is essentially the same in other respects as the gas flow monitor shown in FIG. 1 in the open position, the spacer 16 in this execution example is mounted in the through bore 9 of the guide 6 so as to be adjustable in an axial direction, preferably again by means of a thread arrangement. For this purpose a tappet-shaped extension 19 protrudes in the direction of the closing body 12. The sleeve 10 is pressed onto this extension 19 and the closing spring 15 is again supported on the flange 18 of the sleeve 10, with the other end of the spring holding the closing body 12 in its open position.

On its side facing away from the housing 1 the spacer 16 has a cylindrical extension 20 which is sealed on its front side by a cap 21. The pin 11 extending into the space 23 formed by extension 20 and cap 21 is guided in a longitudinally movable manner on the inner wall via the stop 17 of the pin 11, with the stop 17 and inner wall forming an annular space 22 which forms a constriction to provide the required volume control during the movement of the closing body 12. Because of this arrangement, a short term peak flow whose value is above the closing flow rate does not lead to an abrupt shutting down of the gas flow monitor, but merely initiates a delayed closing movement. After the peak flow has passed, the closing body 12 is moved back to its open position by the closing spring 15. If, however, the closing flow rate is exceeded over an extended period of time, as is the case with leaks, the gas flow monitor assumes the closed position, as shown in FIG. 3.

In assembling the gas flow monitor described in this second execution, the spacer 16 with its tappet-shaped extension 19 is firstly screwed into the guide 6. The sleeve 10 is pressed so far onto the extension 19 that it almost bears on the guide 6. The closing body 12, pin 11 and closing spring are preassembled and the pin 11 is then pushed through the tappet-shaped extension 19 until its end projects into the cylindrical extension 20. The maximum opening lift of the closing body 12 is then set via the stop 17. Before the cap 21 is placed on the spacer 16 as a final step, the adjustment of the gas flow monitor is preferably carried out first in order to avoid longer lead times while the attenuation function fitted to the device is carried out.

The closing or nominal flow rate can also be adjusted via the pretensioning force of the closing spring 15 almost as simply in this execution example as in the first execution example. In an initial step the spacer 16 is unscrewed one turn out of the guide 6. In this process, the sleeve 10 bearing on the guide 6 on the tappet-shaped extension 19 is displaced. The spacer 16 is then re-screwed into the guide 6 up to the stop, with the position of the sleeve 10 on the extension 19 remaining unchanged because of the press fit between both components, whereas the gap between the closing body 12 and the sleeve 10, and thus the bias of the spring 15, alters.

The value of the closing or nominal flow rate is then checked and a readjustment is carried out if necessary by repeating the steps set out above.

### LIST OF REFERENCE NUMERALS

1 Housing

2 Groove

3 O-ring

4 Directional arrow

5 Valve seat

6 Guide

7 Web

8 Through flow opening

9 Through bore

10 Sleeve

11 Pin

12 Closing body

13 Groove

14 O-ring

15 Closing spring

16 Spacer

17 Stop

18 Flange

19 Extension

20 Extension

21 Cap

22 Annular space

23 Space

1. Gas flow monitor for automatically shutting off downstream conduits when a defined maximum flow is exceeded, said monitor comprising:
a gas-tight housing (1) having an inlet side and an outlet side and defining an interior,
a valve seat (5) disposed in the interior of the housing (1) for engaging with an axially movable closing body (12),
a pin (11) guiding the closing body (12),
a guide (6) arranged in the housing (1) on the inlet side in the direction of flow, the guide (6) having through flow openings (8) for the gas flow formed by several radial webs (7),
a sleeve (10) disposed in a center of the housing (1) and adjustable in an axial direction in which the pin (11) is guided in a longitudinally movable manner, and
a closing spring (15) supported on one side on the sleeve (10) and on the other side on the closing body (12), the closing body (12) being held in an open position by the spring force against the flow direction,
wherein the pin (11) is supported on the guide (6) and a stop (17) disposed adjacent the outlet side end and separated from the guide (6) by a tubular spacer (16), wherein the spacer (16) and the sleeve (10) are firmly connected to each other.

2. Gas flow monitor according to claim 1, wherein the spacer (16) comprises a cylindrical extension (20) that is sealed on its front side by a cap (21), and wherein the pin (11) projects into a space (23) enclosed by the extension (20) and the cap (21), with the stop (17) of the pin (11) being guided in a longitudinally movable manner on an inner wall of the extension (20).

3. Gas flow monitor according to claim 1, wherein the housing (1) and the guide (6) are embodied as a single piece.

4. Gas flow monitor according to claim 1, wherein the sleeve (10) is screwed to the guide (6) on one side and pressed onto the spacer (16) on another side.

5. Gas flow monitor according to claim 1, wherein the sleeve (10) is pressed to the guide (6) on one side and screwed to the spacer (16) on the other side.

6. Gas flow monitor according to claim 1, wherein the stop (17) is formed by a flange.

7. Gas flow monitor according to claim 2, wherein the housing (1) and the guide (6) are embodied as a single piece.

8. Gas flow monitor according to claim 2, wherein the sleeve (10) is screwed to the guide (6) on one side and pressed onto the spacer (16) on another side.

9. Gas flow monitor according to claim 3, wherein the sleeve (10) is screwed to the guide (6) on one side and pressed onto the spacer (16) on another side.

10. Gas flow monitor according to claim 7, wherein the sleeve (10) is screwed to the guide (6) on one side and pressed onto the spacer (16) on another side.

11. Gas flow monitor according to claim 2, wherein the sleeve (10) is pressed to the guide (6) on one side and screwed to the spacer (16) on the other side.

12. Gas flow monitor according to claim 3, wherein the sleeve (10) is pressed to the guide (6) on one side and screwed to the spacer (16) on the other side.

13. Gas flow monitor according to claim 7, wherein the sleeve (10) is pressed to the guide (6) on one side and screwed to the spacer (16) on the other side.

14. Gas flow monitor according to claim 2, wherein the stop (17) is formed by a flange.

15. Gas flow monitor according to claim 3, wherein the stop (17) is formed by a flange.

16. Gas flow monitor according to claim 4, wherein the stop (17) is formed by a flange.

17. Gas flow monitor according to claim 5, wherein the stop (17) is formed by a flange.

18. Gas flow monitor according to claim 7, wherein the stop (17) is formed by a flange.
